(19) United States
(12) Patent Application Publication
(10) Pub. No.: US 2021/0284807 A1
(43) Pub. Date: Sep. 16, 2021

(54) PROCESS FOR PRODUCING ALKOXYLATED POLYPHENOLS

(71) Applicant: Arkema France

(72) Inventors: Jean-Philippe Gillet, Brignais (FR); Therry Beillon, Sainte Foy Les Lyon (FR)

(73) Assignee: Arkema France, Colombes Cedex (FR)

(21) Appl. No.: 16/338,854

(22) PCT Filed: Oct. 3, 2017
(86) PCT No.: PCT/FR2017/052722

§ 371 Date: Apr. 2, 2019

(30) Foreign Application Priority Data
Oct. 4, 2016 (FR) 1659586

(51) Int. Cl. C08H 7/00; C08G 65/08

(52) U.S. Cl. CPC C08H 6/00; C08G 65/08

(57) ABSTRACT

The invention relates to a process for producing at least one alkoxylated polyphenol comprising the following successive steps:
(a) reacting at least one polyphenol, at least one alkoxylating agent, at least one catalyst, in the presence of at least one poly (oxyalkylene glycol) as a solvent, at a temperature ranging from 80° C. to 200° C., preferably from 100° C. to 170° C., at a pressure ranging from 0.15 MPa to 2 MPa, preferably from 0.2 MPa to 1.8 MPa; then
(b) removing the residual alkoxylating agent.

The invention relates to a production process for alkoxylated polyphenols, more specifically, alkoxylated lignins.

Lignin is one of the main components of wood, along with cellulose and hemicellulose. After cellulose, lignin is the most abundant biopolymer on Earth. It ensures the rigidity of wood by interpenetrating the cellulose network while conferring resistance to water and some wood pests.

Although abundant, it should be noted that lignin is under-valued as such. Until now, and even till this day, the primary valorisation of lignin is energy valorisation, particularly through the burning of black liquors. This valorisation is important for the economic balance of pulp mills. However, due to the drop in pulp production and lignin surpluses, work is being done for a better valorisation of lignin.

Interest in the use of lignin has therefore grown over the last few years. One area in which the properties of lignin are exploited is the reinforcement of a multitude of polymers, especially urethane-based polymers. Indeed, lignin can be used for the manufacture of polyurethane foam derivatives. Since lignin is a polyphenol, it has a large number of alcohol functional groups capable of reacting, for example with isocyanates to form the polyurethane derivatives. However, since these alcohol functions are difficult to access within this polyphenol, it is necessary to carry out a propoxylation reaction of these functions beforehand, leading to less congested alcohol functions (further from the polyphenol nucleus), and thereby more accessible.

In general, the process used by various authors consists firstly in a propoxylation of lignin by reacting lignin with propylene oxide in the presence of a catalyst and then reacting the obtained product with, for example, isocyanate.

Regarding the lignin propoxylation step, the authors usually operate in autoclaves or Parr bombs. All lignin, for example kraft lignin, is loaded with propylene oxide and a basic catalyst in adequate proportions under a nitrogen atmosphere. The reactor is then closed and heated.

The reaction is initiated around 150° C. with a strong exothermicity that causes a sudden rise in temperature to 250° C. and pressure from a few bars to more than 20 bars. The authors believe that the reaction is complete when the pressure and temperature decrease and reach a stable level.

Given the strong exothermicity of the reaction, the authors must ensure strict control of the reaction conditions for safety reasons. The current process is therefore not industrially transferable.

According to the thesis entitled “Lignin-based Polyurethanes: Characterization, Synthesis and Applications” Borges Cateto, (2008), lignin, propylene oxide and a catalyst are introduced into a closed reactor and are then heated to 160° C. The pressure and temperature increase to a maximum which depends on a number of parameters. Propoxylated lignin is recovered at the end of the reaction. This document states that the reaction was carried out on 100 g samples.

Furthermore, given the temperature conditions, pressure and the residual presence of water, part of the propylene oxide can be homopolymerised, as mentioned in EP2816052. The propoxylated lignin is then mixed with the poly (propylene) glycols, which cannot be readily separated from the propoxylated lignin.

That being said, some authors have succeeded in overcoming the exothermic control issue as mentioned above. In fact, the patent WO2015/083092 describes a process in which a solid lignin dispersion is produced in a di or tetraethylene glycol polyethylene glycol dispersant, or propoxylated glycerol followed by the addition of a base. Then, propylene oxide is added continuously.

Nevertheless, the manufactured product is a mixture of propoxylated lignin and dispersant, optionally propoxylated, difficult to separate from the propoxylated lignin. It should also be noted that the reaction times are extremely long, the temperature during the reaction is low and the pressure during the reaction in use is low.

Similarly, the patent US2015/0038665 discloses a process in which propylene oxide is continuously added to a mixture consisting of lignin, glycerol, lignin polyol and a catalyst. However, this process has the huge disadvantage of leaving a mixture of propoxylated lignin with glycerol or propoxylated glycerol in the finished product.

In addition, it should be noted that the lignin is in solid form. Consequently, it is difficult to use it in the form of a homogeneous reaction medium. It also tends to generate deposits capable of clogging different components of an installation, for example reactors, pipes, valves, ducts, etc. . . . . For this reason, it is also difficult to handle on the industrial level.

The above references disclose the suspension of lignin in dispersants, which can solubilise at least some or all of the lignin. However, these processes require subsequent separation steps to isolate propoxylated lignin from the by-products of the reaction of the dispersant with the reactants. In addition, the reaction conditions used are not necessarily compatible with industrial use.

Thus, there is the need for an industrial alkoxylation process, and especially of propoxylation, polyphenols, such as lignin, enabling sufficient solubilisation and leading to a directly usable product, hence, one capable of being directly engaged in the next step, without the need for an intermediate separation step.

The purpose of the present invention is to propose a solution that would solve all of the above-mentioned problems.

Thus, the subject of the present invention is a process for the production of at least one alkoxylated polyphenol comprising the following successive stages:
(a) reacting at least one polyphenol, at least one alkoxylating agent, at least one catalyst, in the presence of at least one poly (oxyalkylene glycol) as a solvent, at a temperature ranging from 80° C. to 200° C., preferably from 100° C. to 170° C., at a pressure ranging from 0.15 to 2 MPa, preferably from 0.2 MPa to 1.8 MPa; then
(b) removing the residual alkoxylating agent.

The process according to the invention facilitates the synthesizing of alkoxylated polyphenol under good safety conditions, in order to enable the possibility for it to be carried out at an industrial scale. Indeed, the operating conditions in terms of temperature and pressure are controlled by the process according to the invention. The exothermicity of the reaction is particularly supervised. In addition, the process according to the invention makes it possible to obtain an alkoxylated polyphenol with a good yield and with very reasonable reaction times compatible with industrial use.

Furthermore, the alkoxylated polyphenol obtained from the process according to the invention can be used in crude state without purification. The process according to the invention also has the advantage of not restricting the use of alkoxylating agent to propylene oxide only. For example, ethylene oxide and/or butylene oxide or mixtures thereof can also be used.

It should be noted that the expressions “from . . . to . . . ” used in the present description must be understood as including each of the mentioned limits. Throughout the text, pressures are expressed in absolute MegaPascals (MPa).

Step (a):

The process according to the invention comprises a step (a) involving the reaction of at least one polyphenol, at least one alkoxylating agent, at least one catalyst, in the presence of at least one poly (oxyalkylene glycol) as a solvent, at a temperature ranging from 80° C. to 200° C., preferably from 100° C. to 170° C., at a pressure ranging from 0.15 MPa to 2 MPa, preferably from 0.2 MPa to 1.8 MPa.

Polyphenols:

The polyphenols used in the process according to the invention may be selected from natural tannins, lignins and polyphenols other than tannins and lignins. Advantageously, said polyphenol is a lignin, preferably selected from kraft lignin, lignosulphonates and organosolv lignins.

Kraft lignin is derived from the paper-making process of the same name. In terms of chemical structure, kraft lignin is a combination of three phenolic compounds, coumaryl alcohol, coniferyl alcohol and sinapyl alcohol. Examples of kraft lignin suitable for use include inter alia Indulin AT™ marketed by the Ingevity company, the kraft lignin marketed by the Fibria company, or the lignin marketed by the Stora Enso company.

Lignosulphonates differ structurally from kraft lignin by additional generally salified sulfonic functions, which give them better solubility in water. Examples of lignosulfonates include Borresperse™, Ultrazine™, Ufoxane™ or even Vanisperse™ type lignosulfonates.

Organosolv lignins are obtained by chemical attack of woody plants, such as cereal straw, using various solvents, like formic acid or acetic acid. Among the various sources of organosolv lignins is Biolignin™, marketed by the CIMV company or marketed by the Fibria company.

Preferably, the polyphenol used is lignin.

Alkoxylating Agents:

The alkoxylating agents used in the process according to the invention may be selected from those of formula (I) below:

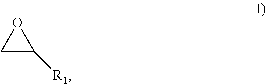

wherein R₁ denotes a hydrogen atom or an alkyl radical in C₁-C₆.

Preferably, R₁ denotes a hydrogen atom or an alkyl radical in C₁-C₂. Thus, the alkoxylating agent is particularly preferably selected from ethylene oxide, propylene oxide, butylene oxide, and mixtures thereof, preferably propylene oxide.

Preferably, the polyphenol/alkoxylating agent weight ratio ranges from 0.05 to 2, preferably from 0.1 to 1, more preferably from 0.15 to 0.9, more preferably from 0.15 to 0.7.

Catalyst:

The catalyst used in the process according to the invention may be selected from alkali metal hydroxides, sodium or potassium alkoxides, and tertiary amines selected from trialkylamines and tetramethylguanidine, preferably selected from alkaline metal hydroxides.

More preferably, the catalyst used in the process according to the invention may be selected from lithium hydroxide, sodium hydroxide, potassium hydroxide and caesium hydroxide.

Advantageously, the catalyst represents from 0.01% to 10% weight, preferably from 1% to 6% weight in relation to the weight of polyphenol.

Poly (oxyalkylene):

Advantageously, said poly (oxyalkylene glycol) is selected from polypropylene glycol, polybutylene glycol, alternating or random block copolymers obtained from these monomers, and mixtures thereof. The alkoxylated polyphenol obtained using this specific poly (oxyalkylene glycol) is advantageously a liquid and homogeneous product.

Preferably, the poly (oxyalkylene glycol) used in the process according to the invention is selected from dipropylene glycol, tripropylene glycol, tetrapropylene glycol, polypropylene glycol 220, polypropylene glycol 400 and mixtures thereof, more preferably selected from polypropylene glycol 220, polypropylene glycol 400 and mixtures thereof.

Preferably, the molar mass of the poly (oxyalkylene glycol) is greater than or equal to 100 g/mol⁻¹, more specifically ranges from 100 g/mol⁻¹ to 6000 g/mol⁻¹, and even more preferably 150 g/mol⁻¹ to 2000 g/mol⁻¹.

According to a particular embodiment of the invention, the polyphenol/poly (oxyalkyleneglycol) weight ratio is less than or equal to 2, preferably less than or equal to 1, more preferably less than or equal to 0.5.

Preferably, the polyphenol/poly(oxyalkyleneglycol) weight ratio is greater than or equal to 0.05. Advantageously, the polyphenol/poly (oxyalkyleneglycol) weight ratio ranges from 0.05 to 0.5. According to a preferred embodiment of the process according to the invention, the poly (oxyalkylene glycol) constitutes the only solvent of the reaction medium of step (a).

Reaction Conditions:

Step (a) according to the invention is carried out at a temperature ranging from 80° C. to 200° C., preferably from 100° C. to 170° C. The reaction pressure ranges from 0.15 MPa to 2 MPa, preferably from 0.2 MPa to 1.8 MPa, more preferably from 0.2 MPa to 0.6 MPa.

Preferably, the duration of step (a) varies from a few minutes to several hours, preferably from 5 minutes to 72 hours, more preferably from 10 minutes to 24 hours, even more preferably from 10 minutes to 12 hours.

Step (b):

As indicated above, the process according to the invention comprises a step (b) of removing the residual alkoxylating agent. For the purposes of the present invention, the term “residual alkoxylating agent” refers to an un-reacted alkoxylating agent.

Preferably, said step of removing the residual alkoxylating agent is carried out by cooking, meaning by maintaining a temperature ranging from 70° C. to 170° C., preferably from 70° C. to 130° C. to consume the residual alkoxylating agent, and/or by a stripping step under an inert gas stream. Alternatively, said stripping step may be carried out under steam or under vacuum.

Preferably, after said step (b), the mass content of residual alkoxylating agent is less than or equal to 1% in relation to the weight of alkoxylated polyphenol obtained at the end of step (b), preferably less than or equal to 0.1%, more preferably less than or equal to 0.01%.

The alkoxylated polyphenol obtained is in the form of a dark-coloured viscous liquid.

The raw product is directly usable as is for the manufacture of rigid polyurethane foam (PU) derivatives, for thermal insulation for example. For other applications, traces of catalyst can be removed by methods known to the person skilled in the art.

Preferably, the process according to the invention comprises the following successive stages:
(a1) mixing least one polyphenol, at least one poly (oxyalkylene glycol) as solvent in the aforementioned proportions, and at least one catalyst in a reactor;
(a2) optionally drying the mixture;
(a3) adding at least one alkoxylating agent to the mixture.

Advantageously, step (a) is carried out at a temperature ranging from 80° C. to 200° C., preferably from 100° C. to 170° C., under a pressure ranging from 0.15 MPa to 2 MPa, preferably from 0.2 MPa to 1.8 MPa.

Preferably, the optional step (b) of drying the mixture is carried out by stripping with nitrogen or with steam.

Furthermore, the process can be implemented batchwise, semi-continuously or continuously.

According to a first variant of the process according to the invention, the process according to the invention consists of a batch or semi-continuous process. In this variant, step (a) can be decomposed into 3 successive steps:
(a1) mixing at least one polyphenol, at least one poly (oxyalkylene glycol) as a solvent in the aforementioned proportions, and at least one catalyst, in a reactor, at a temperature ranging from 80 to 200° C., preferably from 100 to 170° C., at a pressure of from 0.15 to 2 MPa, preferably from 0.2 to 1.8 MPa;
(a2) optionally drying the mixture;
(a3) adding at least one alkoxylating agent to the mixture in at least one semi-continuous step.

The optional step (a2) consists in removing the water possibly formed during the reaction of the catalyst with the polyphenol or brought by the catalyst in aqueous solution. This drying step (a2) can be carried out by hot nitrogen stripping, meaning at a temperature ranging from 50° C. to 130° C., and optionally under reduced pressure between 0.002 MPa and 0.1 MPa.

In step (a3), the reactor is purged with nitrogen. It is pressurized at a pressure ranging from 0.15 MPa to 0.4 MPa, and the reaction medium is heated with stirring at a temperature ranging from 100° C. to 150° C.

The alkoxylating agent or the mixture of alkoxylating agents is then introduced semi-continuously at an introduction rate making it possible to control the temperature and the safety pressure. The reaction is carried out at a temperature of from 80° C. to 200° C. with a preference of 100° C. to 170° C. The pressure varies according to the type of reactor and the filling rate of the latter and varies from 0.15 MPa to 2 MPa.

At the end of the reaction, step (b) is carried out to remove the residual alkoxylating agent, which consists in consuming the remainder of the alkoxylating agent by maintaining the temperature. There is a drop in pressure until theoretical pressure is reached due to nitrogen alone. It is also possible to carry out a stripping step with an inert gas, such as nitrogen, or with steam and/or under vacuum, to remove the last traces of alkoxylating agent.

A second variant of the process according to the invention is a continuous type process, comprising the following successive stages:
(a1) mixing in a reactor at least one polyphenol, at least one poly (oxyalkylene glycol) as a solvent according to the aforementioned proportions, and at least one catalyst, at a temperature ranging from 80 to 200° C., preferably from 100 to 170° C., under a pressure ranging from 0.15 to 2 MPa, preferably from 0.2 to 1.8 MPa, said polyphenol, said poly (oxyalkylene glycol) and said catalyst being added continuously,
(a2) optionally drying the mixture;
(a3) adding at least one alkoxylating agent in at least one continuous step, while continuously withdrawing the reaction medium.

Step (a1) is carried out by feeding polyphenol, poly (oxyalkylene glycol) and the catalyst into a reactor. The reactor may be a stirred tank or a mixing device such as an extruder. This step can be carried out continuously with uninterrupted feeding of the reagents and a continuous withdrawal of the reaction mixture formed.

It can also be performed in batch with a sequential supply of reagents, then a mixing step and a drying step as described in the first variant. The reaction mixture produced can then be continuously sent to step (a3).

In step (a3), the reaction mixture resulting from step (a1) or optionally from step (a2) and at least one alkoxylating agent are continuously added to a reactor system, which may consist of a continuous stirred tank or cascade of continuous stirred tanks or an extruder. Crude alkoxylated polyphenol is withdrawn continuously from the reactor system.

Preferably, step (a3) comprises a cascade of 2 to 6 continuous stirred tanks. The first tank is continuously fed with the reaction mixture from step (a1) or step (a2) and each subsequent tank is continuously fed with the stream withdrawn from the previous tank.

Advantageously, each continuously stirred tank is continuously fed with a portion of the alkoxylating agent flow in order to obtain a tighter polydispersity of alkoxylated polyphenol product.

Preferably, the process according to the invention comprises a step (c) of recovering the alkoxylated polyphenol obtained after step (b).

Another purpose of the present invention is an alkoxylated polyphenol obtainable by the process according to the invention.

The invention also relates to the use of poly (oxyalkylene glycol) as a solvent in a process for producing alkoxylated polyphenols, especially such as defined above.

Another subject of the present invention is the use of alkoxylated polyphenol obtained by the process according to the invention for producing polyurethanes, polyesters, non-ionic or cationic surfactants, biosourced precursors of carbon fibre.

The present invention is further illustrated by the following non-limiting examples.

### EXAMPLES

### Example 1 (According to the Invention): Synthesis of Propoxylated Lignin in the Presence of PPG 220

208.4 g of Indulin AT™ lignin, previously dried in an oven, in 479.3 g of polypropylene glycol 220 (PPG 220) and 8.3 g of finely ground caesium hydroxide are added into a 6 L autoclave. The weight ratio of lignin/PPG 220 is 43.5% by weight and the catalyst/lignin weight ratio is 4% by weight.

3 purges are successively carried out with nitrogen. Leak tests are also carried out. The temperature is gradually increased with stirring of the reaction medium to 80° C. Nitrogen is re-pressurized to 0.25 MPa and then a 50 g fraction of propylene oxide is introduced. The temperature is gradually raised to a temperature of 120° C., at which temperature the attachment of the reaction can be observed.

The total propylene oxide, 488 g, is introduced at a temperature ranging from 120° C. to 130° C., at a maximum pressure of 0.6 MPa and at an average flow rate of 140 g/h⁻¹. The temperature is maintained at 130° C. until a pressure level is reached. At the end of the addition, the mixture is left with stirring for one hour in order for all the propylene oxide to be consumed, then the residue is stripped with nitrogen for 1 hour at 80° C.

1125 g of product are recovered in the form of a dark viscous liquid. The product is homogeneous and does not contain unreacted lignin grain. Its hydroxyl number (I_{OH}) is 290 mg of KOH/g⁻¹.

### Example 2 (According to the Invention): Synthesis of Propoxylated Lignin in the Presence of PPG 400

215 g of Indulin AT™ lignin, previously dried in an oven, in 500 g of polypropylene glycol 400 (PPG 400) and 8.6 g of finely ground caesium hydroxide are added into a 6 L autoclave. The weight ratio of lignin/PPG 400 is 43% by weight and the catalyst/lignin weight ratio is 4% by weight.

3 purges are successively carried out with nitrogen. Leak tests are also carried out. The temperature is gradually increased with stirring of the reaction medium to 80° C. Nitrogen is re-pressurized to 0.25 MPa and then a 50 g fraction of propylene oxide is introduced. The temperature is gradually raised to a temperature of 130° C., at which temperature the attachment of the reaction can be observed.

The total propylene oxide, 500 g, is introduced at a temperature ranging from 130° C. to 140° C. and at a maximum pressure of 0.6 MPa and at an average flow rate of 85 g/h⁻¹. The temperature is maintained at 130° C. until a pressure level is reached. At the end of the addition, the mixture is left with stirring for one hour in order for all the propylene oxide to be consumed, then the residue is stripped with nitrogen for 1 hour at 80° C.

1100 g of product are recovered in the form of a dark viscous liquid. The product is homogeneous and does not contain unreacted lignin grain. Its hydroxyl number (I_{OH}) is 202 mg of KOH/g⁻¹.

1. A process for producing at least one alkoxylated polyphenol comprising the following successive steps:
(a) reacting at least one polyphenol, at least one alkoxylating agent, at least one catalyst, in the presence of at least one poly (oxyalkylene glycol) as a solvent, at a temperature ranging from 80° C. to 200° C., at a pressure ranging from 0.15 to 2 MPa; then
(b) removing the residual alkoxylating agent.

2. The process according to claim 1, wherein said polyphenol is selected from natural tannins, lignins and polyphenols other than tannins and lignins.

3. Process according to claim 2, wherein said polyphenol is a lignin.

4. Process according to claim 1, wherein said alkoxylating agent has the following formula (I): 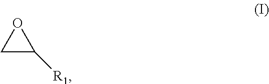
wherein R₁ denotes a hydrogen atom or an alkyl radical in C₁-C₆.

5. A process according to claim 1, wherein said alkoxylating agent is selected from ethylene oxide, propylene oxide, butylene oxide, and mixtures thereof.

6. Process according to claim 1, wherein the polyphenol/alkoxylating agent weight ratio ranges from 0.05 to 2.

7. Process according to claim 1, wherein the catalyst is selected from alkali metal hydroxides, sodium or potassium alkoxides, and tertiary amines selected from trialkylamines and tetramethylguanidine, preferably selected from alkali metal hydroxides.

8. Process according to claim 1, wherein said poly (oxyalkylene glycol) is selected from polypropylene glycol, polybutylene glycol, alternating or random block copolymers obtained from the monomers, and mixtures thereof.

9. Process according to claim 1, wherein said poly (oxyalkylene glycol) is selected from dipropylene glycol, tripropylene glycol, tetrapropylene glycol, polypropylene glycol 220, polypropylene glycol 400 and mixtures thereof.

10. Process according to claim 1, wherein the polyphenol/poly (oxyalkyleneglycol) weight ratio is less than or equal to 2.

11. Process according to claim 1, wherein it is carried out batchwise, semi-continuously or continuously.

12. Process according to claim 1, comprising a step (c) of recovering the alkoxylated polyphenol obtained after step (b).

13. An alkoxylated polyphenol obtainable by the process as defined in claim 1.

14. Use of poly (oxyalkylene glycol) as a solvent in a process for producing alkoxylated polyphenols.

15. Use of the alkoxylated polyphenol obtained by the process as defined in claim 1 for producing polyurethanes, polyesters, non-ionic or cationic surfactants, biosourced carbon fibre precursors.
